(19) United States
(12) Patent Application Publication
(10) Pub. No.: US 2024/0084178 A1
(43) Pub. Date: Mar. 14, 2024

(54) TWO-PART, CYANOACRYLATE/FREE RADICALLY CURABLE ADHESIVE SYSTEMS

(71) Applicant: Henkel AG & Co. KGaA, Duesseldorf (DE)

(72) Inventors: Laxmisha M. Sridhar, Monmouth Junction, NJ (US); Chetan Hire, Glastonbury, CT (US); Shabbir T. Attarwala, Simsbury, CT (US); Joseph Schulz, Newington, CT (US); Roger Grismala, Enfield, CT (US)

(21) Appl. No.: 18/497,729

(22) Filed: Oct. 30, 2023

Related U.S. Application Data
(63) Continuation of application No. PCT/US2022/026884, filed on Apr. 29, 2022.
(60) Provisional application No. 63/182,013, filed on Apr. 30, 2021.

(51) Int. Cl. C09J 133/14; C09J 11/04; C09J 175/06

(52) U.S. Cl. CPC C09J 133/14; C09J 11/04; C09J 175/06; C09J 2301/312

(57) ABSTRACT

Two part cyanoacrylate/free radical curable adhesive systems are provided.

### BACKGROUND

### Field

Two part cyanoacrylate/free radically curable adhesive systems are provided, which show improved lap shear strength and hot strength.

### Brief Discussion of Related Technology

Curable compositions such as cyanoacrylate adhesives are well recognized for their excellent ability to rapidly bond a wide range of substrates, generally in a number of minutes and depending on the particular substrate, often in a number of seconds.

Polymerization of cyanoacrylates is initiated by nucleophiles found under normal atmospheric conditions on most surfaces. The initiation by surface chemistry means that sufficient initiating species are available when two surfaces are in close contact with a small layer of cyanoacrylate between the two surfaces. Under these conditions a strong bond is obtained in a short period of time. Thus, in essence the cyanoacrylate often functions as an instant adhesive.

Cyanoacrylate adhesive performance, particularly durability, oftentimes becomes suspect when exposed to elevated temperature conditions and/or high relative humidity conditions. To combat these application-dependent shortcomings, a host of additives have been identified for inclusion in cyanoacrylate adhesive formulations. Improvements would still be seen as beneficial.

A variety of additives and fillers have been added to cyanoacrylate compositions to modify physical properties.

For instance, U.S. Pat. No. 3,183,217 (Serniuk) discloses free radical polymerization of a methacrylic acid or methyl methacrylate monomer with a non-polar or mildly polar olefin where the monomer is complexed with a Friedel-Crafts halide.

U.S. Pat. No. 3,963,772 (Takeshita) discloses liquid telomers of alkylene and acrylic monomers which result in short chain alternating copolymers substantially terminated at one end of the polymer chains with the more reactive alkylene units. The liquid telomers are useful in making elastomeric polymers for high molecular weight rubbers which permit the ready incorporation of fillers, additives, and the like, due to its liquid phase.

U.S. Pat. No. 4,440,910 (O'Connor) is directed to cyanoacrylate compositions having improved toughness, achieved through the addition of elastomers, i.e., acrylic rubbers. These rubbers are either (i) homopolymers of alkyl esters of acrylic acid; (ii) copolymers of another polymerizable monomer, such as lower alkenes, with an alkyl ester of acrylic acid or with an alkoxy ester of acrylic acid; (iii) copolymers of alkyl esters of acrylic acid; (iv) copolymers of alkoxy esters of acrylic acid; and (v) mixtures thereof.

U.S. Pat. No. 4,560,723 (Millet) discloses a cyanoacrylate adhesive composition containing a toughening agent comprising a core-shell polymer and a sustainer comprising an organic compound containing one or more unsubstituted or substituted aryl groups. The sustainer is reported to improve retention of toughness after heat aging of cured bonds of the adhesive. The core-shell polymer is treated with an acid wash to remove any polymerization-causing impurities such as salts, soaps or other nucleophilic species left over from the core-shell polymer manufacturing process.

U.S. Pat. No. 5,340,873 (Mitry) discloses a cyanoacrylate adhesive composition having improved toughness by including an effective toughening amount of a polyester polymer derived from a dibasic aliphatic or aromatic carboxylic acid and a glycol.

U.S. Pat. No. 5,994,464 (Ohsawa) discloses a cyanoacrylate adhesive composition containing a cyanoacrylate monomer, an elastomer miscible or compatible with the cyanoacrylate monomer, and a core-shell polymer being compatible, but not miscible, with the cyanoacrylate monomer.

U.S. Pat. No. 6,833,196 (Wojciak) discloses a method of enhancing the toughness of a cyanoacrylate composition between steel and EPDM rubber substrates. The disclosed method is defined by the steps of: providing a cyanoacrylate component; and providing a toughening agent comprising methyl methacrylic monomer and at least one of butyl acrylic monomer and isobornyl acrylic monomer, whereby the acrylic monomer toughening agent enhances the toughness of the cyanoacrylate composition such that whereupon cure, the cyanoacrylate composition has an average tensile shear strength of over about 4400 psi after 72 hours at room temperature cure and 2 hours post cure at 121° C.

Reactive acrylic adhesives that cure by free radical polymerization of (meth)acrylic esters (i.e., acrylates) are known, but suffer from certain drawbacks. Commercially important acrylic adhesives tend to have an offensive odor, particularly those that are made from methyl methacrylate. Methyl methacrylate-based acrylic adhesives also have low flash points (approximately 59° F.). Low flash points are particularly an issue during storage and transportation of the adhesives. If the flash point is 141° F. or lower, the U.S. Department of Transportation classifies the product as “Flammable” and requires marking and special storage and transportation conditions.

U.S. Pat. No. 6,562,181 (Righettini) intended to provide a solution to the problem addressed in the preceding paragraph by describing an adhesive composition comprising: (a) a trifunctional olefinic first monomer comprising an olefinic group that has at least three functional groups each bonded directly to the unsaturated carbon atoms of the olefinic group; (b) an olefinic second monomer that is copolymerizable with the first monomer; (c) a redox initiator system, and (d) a reactive diluent, where the composition is a liquid at room temperature is 100% reactive and substantially free of volatile organic solvent, and is curable at room temperature.

Recently, U.S. Pat. No. 9,371,470 (Burns) issued with claims directed to a two part curable composition comprising (a) a first part comprising a cyanoacrylate component and t-butyl perbenzoate as a peroxide catalyst present in an amount from about 0.01% to about 10%, by weight of the cyanoacrylate component; and (b) a second part comprising a free radical curable component and a transition metal. When mixed together the peroxide catalyst initiates cure of the free radical curable component and the transition metal initiates cure of the cyanoacrylate component.

Notwithstanding the state of the art, it would be desirable to provide alternative adhesive systems having both the features of an instant adhesive, such as in terms of the fast fixture times and ability to bond a wide range of substrates such as metals and plastics observed with cyanoacrylates, together with the improved bond strength (particularly lap shear and hot strength) over a greater variety and/or selection of substrates seen with (meth)acrylate compositions. By so doing, the end user is given a greater variety of possible solutions from which to make a choice appropriate to the problem s/he is facing.

### SUMMARY

There is provided in one aspect a two part cyanoacrylate/free radically curable composition comprising:
(a) a first part comprising a cyanoacrylate component and a peroxide component; and
(b) a second part comprising a free radical curable component and a transition metal, at least a portion of which comprises a polyester urethane (meth)acrylate having a Tg of greater than about 50° C., such as greater than about 60° C. like greater than about 70° C.

The second part should also include one or more of an aliphatic urethane diacrylate having a Tg of greater than about 30° C.; an anhydride; and at least one maleimide-, itaconimide- or nadimide-containing compound.

The aliphatic urethane diacrylate should have a Tg of greater than about 30° C.

The polyester urethane (meth)acrylate and when present the aliphatic urethane diacrylate should be in about a 2:1 by weight ratio.

The polyester urethane (meth)acrylate has a molecular weight of about 2000 to about 5000 Mn, such as about 3500 Mn.

The aliphatic urethane diacrylate has a molecular weight of about 900 to about 2000 Mn, such as about 1400 Mn.

The first part and the second part should be mixed together so the peroxide component initiates cure of the free radical curable component in combination with the metal salt.

The composition, when the first part and the second part are mixed together and cured, a cured composition demonstrates at least one of lap shear strength on epoxy substrates of greater than about 1000 psi, such as greater than about 1500 psi, and hot strength at a temperature of 120° C. on grit blasted mild steel substrates of greater than about 300 psi, such as greater than about 400 psi.

The compositions, which are room temperature stable as the first part and the second part do not interact prior to use on mixing, provide good performance across substrates constructed from a wide variety of materials and provide improved durability performance over conventional cyanoacrylate compositions and improved lap shear strength and hot strength over conventional free radical curable compositions.

### DETAILED DESCRIPTION

As noted above, there is provided in one aspect a two part cyanoacrylate/free radically curable composition comprising:
(a) a first part comprising a cyanoacrylate component and a peroxide component; and
(b) a second part comprising a free radical curable component and a transition metal, at least a portion of which comprises a polyester urethane (meth)acrylate having a Tg of greater than about 50° C., such as greater than about 60° C. like greater than about 70° C.

The second part should also include one or more of an aliphatic urethane diacrylate having a Tg of greater than about 30° C.; an anhydride; and at least one maleimide-, itaconimide- or nadimide-containing compound.

The polyester urethane (meth)acrylate and when present the aliphatic urethane diacrylate should be used in about a 2:1 by weight ratio.

The polyester urethane (meth)acrylate has a molecular weight of about 2000 to about 5000 Mn, such as about 3500 Mn.

The aliphatic urethane diacrylate has a molecular weight of about 900 to about 1900 Mn, such as about 1400 Mn.

The first part and the second part should be mixed together so the peroxide component initiates cure of the free radical curable component.

The composition, when the first part and the second part are mixed together and cured, a cured composition demonstrates at least one of lap shear strength on epoxy substrates of greater than about 1000 psi, such as greater than about 1500 psi, and hot strength at a temperature of 120° C. on grit blasted mild steel substrates of greater than about 300 psi, such as greater than about 400 psi.

### Part A

The cyanoacrylate component includes cyanoacrylate monomers, such as those represented by H₂C═C(CN)—COOR, where R is selected from C₁₋₁₅ alkyl, C₂₋₁₅ alkoxyalkyl, C₂₋₁₅ cycloalkyl, C₂₋₁₅ alkenyl, C₇₋₁₅ aralkyl, C₆₋₁₅ aryl, C₃₋₁₅ allyl and C₁₋₁₅ haloalkyl groups. Desirably, the cyanoacrylate monomer is selected from methyl cyanoacrylate, ethyl-2-cyanoacrylate (“ECA”), propyl cyanoacrylates, butyl cyanoacrylates (such as n-butyl-2-cyanoacrylate), octyl cyanoacrylates, allyl cyanoacrylate, methoxyethyl cyanoacrylate and combinations thereof. A particularly desirable one is ethyl-2-cyanoacrylate.

The cyanoacrylate component should be included in the Part A composition in an amount within the range of from about 50 percent by weight to about 99.98 percent by weight, such as about 70 percent by weight to about 99 percent by weight being desirable, and about 80 percent by weight to about 97 percent by weight of the Part A composition being particularly desirable.

As the peroxide component to be included in the Part A composition of the two part adhesive system, a host of material may be used. For instance, as the peroxide catalyst to be included in the Part A composition, perbenzoates should be used, such as t-butylperbenzoate.

Typically, the amount of peroxide catalyst should fall in the range of about 0.001 percent by weight up to about 10.00 percent by weight of the composition, desirably about 0.01 percent by weight up to about 5.00 percent by weight of the composition, such as about 0.50 to 2.50 weight percent of the composition.

Additives may be included in the Part A composition of the adhesive system to modify physical properties, such as improved fixture speed, improved shelf-life stability, flexibility, thixotropy, increased viscosity, color, and improved toughness. Such additives therefore may be selected from accelerators, free radical stabilizers, anionic stabilizers, gelling agents, thickeners [such as PMMAs], thixotropy conferring agents (such as fumed silica), dyes, toughening agents, plasticizers and combinations thereof.

One or more accelerators may also be used in the adhesive system, particularly, in the Part A composition, to accelerate cure of the cyanoacrylate component. Such accelerators may be selected from calixarenes and oxacalixarenes, silacrowns, crown ethers, cyclodextrins, poly(ethyleneglycol) di(meth)acrylates, ethoxylated hydric compounds and combinations thereof.

Of the calixarenes and oxacalixarenes, many are known, and are reported in the patent literature. See e.g. U.S. Pat. Nos. 4,556,700, 4,622,414, 4,636,539, 4,695,615, 4,718,966, and 4,855,461, the disclosures of each of which are hereby expressly incorporated herein by reference.

For instance, as regards calixarenes, those within the structure below are useful herein:

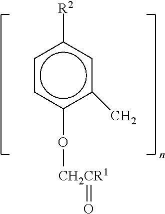

where R¹ is alkyl, alkoxy, substituted alkyl or substituted alkoxy; R² is H or alkyl; and n is 4, 6 or 8.

One particularly desirable calixarene is tetrabutyl tetra[2-ethoxy-2-oxoethoxy]calix-4-arene.

A host of crown ethers are known. For instance, examples which may be used herein either individually or in combination include 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclahexyL-24-crown-8, cyclohexyl-12-crown-4, 1,2-decalyl-15-crown-5, 1,2-naphtho-15-crown-5, 3,4,5-naphtyl-16-crown-5, 1,2-methyl-benzo-18-crown-6, 1,2-methylbenzo-5, 6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6 and 1,2-benzo-1,4-benzo-5-oxygen-20-crown-7. See U.S. Pat. No. 4,837,260 (Sato), the disclosure of which is hereby expressly incorporated here by reference.

Of the silacrowns, again many are known, and are reported in the literature. For instance, a typical silacrown may be represented within the structure below:

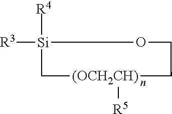

where R³ and R⁴ are organo groups which do not themselves cause polymerization of the cyanoacrylate monomer, R⁵ is H or CH₃ and n is an integer of between 1 and 4. Examples of suitable R³ and R⁴ groups are R groups, alkoxy groups, such as methoxy, and aryloxy groups, such as phenoxy. The R³ and R⁴ groups may contain halogen or other substituents, an example being trifluoropropyl. However, groups not suitable as R⁴ and R⁵ groups are basic groups, such as amino, substituted amino and alkylamino.

Specific examples of silacrown compounds useful in the inventive compositions include:

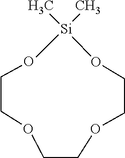

dimethylsila-ll-crown-4;

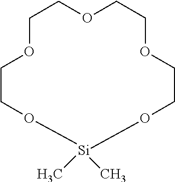 [SMILES: C[Si]1(C)OCCOCCOCCOCCO1]

dimethylsila-14-crown-5;

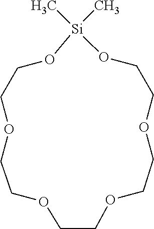 [SMILES: C[Si]1(C)OCCOCCOCCOCCOCCO1]

and dimethylsila-17-crown-6. See e.g. U.S. Pat. No. 4,906,317 (Liu), the disclosure of which is hereby expressly incorporated herein by reference.

Many cyclodextrins may be used in connection with the present invention. For instance, those described and claimed in U.S. Pat. No. 5,312,864 (Went), the disclosure of which is hereby expressly incorporated herein by reference, as hydroxyl group derivatives of an α, β or γ-cyclodextrin which is at least partly soluble in the cyanoacrylate would be appropriate choices for use herein as an accelerator component.

In addition, poly(ethylene glycol) di(meth)acrylates suitable for use herein include those within the structure below:

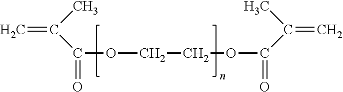

where n is greater than 3, such as within the range of 3 to 12, with n being 9 as particularly desirable. More specific examples include PEG 200 DMA (where n is about 4), PEG 400 DMA (where n is about 9), PEG 600 DMA (where n is about 14), and PEG 800 DMA (where n is about 19), where the number (e.g., 400) represents the average molecular weight of the glycol portion of the molecule, excluding the two methacrylate groups, expressed as grams/mole (i.e., 400 g/mol). A particularly desirable PEG DMA is PEG 400 DMA.

And of the ethoxylated hydric compounds (or ethoxylated fatty alcohols that may be employed), appropriate ones may be chosen from those within the structure below:

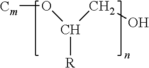

where Cₘ can be a linear or branched alkyl or alkenyl chain, m is an integer between 1 to 30, such as from 5 to 20, n is an integer between 2 to 30, such as from 5 to 15, and R may be H or alkyl, such as C₁₋₆ alkyl.

In addition, accelerators embraced within the structure below:

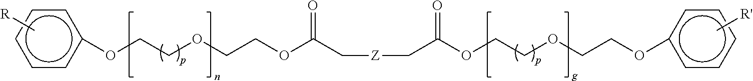

where R is hydrogen, C₁₋₆ alkyl, C₁₋₆ alkyloxy, alkyl thioethers, haloalkyl, carboxylic acid and esters thereof, sulfinic, sulfonic and sulfurous acids and esters, phosphinic, phosphonic and phosphorous acids and esters thereof, Z is a polyether linkage, n is 1-12 and p is 1-3 are as defined above, and R′ is the same as R, and g is the same as n.

A particularly desirable chemical within this class as an accelerator component is

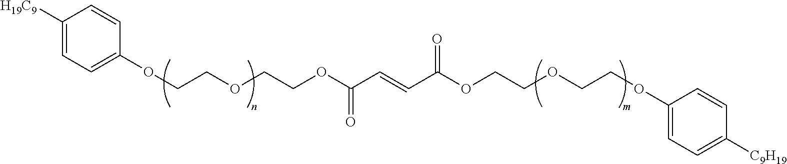

where n and m combined are greater than or equal to 12.

The accelerator should be included in the composition in an amount within the range of from about 0.01 percent by weight to about 10 percent by weight, with the range of about 0.1 to about 0.5 percent by weight being desirable, and about 0.4 percent by weight of the total composition being particularly desirable.

Stabilizers useful in the Part A composition of the adhesive system include free-radical stabilizers, anionic stabilizers and stabilizer packages that include combinations thereof. The identity and amount of such stabilizers are well known to those of ordinary skill in the art. See e.g. U.S. Pat. Nos. 5,530,037 and 6,607,632, the disclosures of each of which are hereby incorporated herein by reference. Commonly used free-radical stabilizers include hydroquinone, while commonly used anionic stabilizers include boron trifluoride, boron trifluoride-etherate, sulphur trioxide (and hydrolysis products thereof) and methane sulfonic acid.

### Part B

The free radically curable component for use in the Part B composition of the adhesive system includes (meth)acrylate monomers and oligomers.

(Meth)acrylate monomers include a host of (meth)acrylate monomers, with some of the (meth)acrylate monomers being aromatic, while others are aliphatic and still others are cycloaliphatic. Examples of such (meth)acrylate monomers include di-or tri-functional (meth)acrylates like polyethylene glycol di(meth)acrylates, tetrahydrofuran (meth) acrylates and di(meth)acrylates, hydroxypropyl (meth)acrylate (“HPMA”), hexanediol di(meth)acrylate, trimethylol propane tri(meth)acrylate (“TMPTMA”), diethylene glycol dimethacrylate, triethylene glycol dimethacrylate (“TRIEGMA”), benzylmethacrylate, tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), bisphenol-F mono and di(meth)acrylates, such as ethoxylated bisphenol-F (meth) acrylate, and methacrylate-functional urethanes.

Typically, the free radically curable component should be present in the Part B composition in an amount of about 50 percent by weight up to about 98 percent by weight of the composition, desirably about 80 percent by weight up to about 95 percent by weight of the composition, such as about 85 to about 92 percent by weight of the composition.

As part of the free radically curable component, Part B also includes a polyester urethane (meth)acrylate having a Tg of greater than about 50° C., such as about 60° C. like about 70° C., and an aliphatic urethane diacrylate having a Tg of greater than about 30° C.

Desirably, as noted above and herein, the polyester urethane (meth)acrylate should have a Tg of greater than about 60° C., and more desirably even greater than about 70° C.

An example of a useful polyester urethane (meth)acrylate is a block resin noted as cyclohexanol, 4,4-(1-methylethylidene)bis-, polymer with 1,3-disocyanatomethylbenzene and tetrahydrofuran, propylene glycol monomer (CAS No. 2243075-64-9), made in sequential steps from the reaction of the propylene glycol monomer and dicarboxylic acids to form polyester diols, followed by reaction with toluene diisocyanate and finally capping with hydroxy propyl(meth)acrylate. Several other short chain diols and dicarboxylic acids can be used to make polyester polyols. Typical diacids used in the synthesis of polyester polyols include phthalic acid, isophthalic acid, terephthalic acid, adipic acid, and furan 2,4-dicarboxylic acid. The short chain diols used in the synthesis of polyester polyols include propane-1,3-diol, neopentyl glycol, and tetramethylcyclobutanediol. Several other commercially available diisocyanates can be used in the synthesis of polyester urethane acrylate oligomers, such as IPDI and hydrogenated MDI.

Among the polyester urethane (meth)acrylates are those based on polyesters, which are reacted with aromatic, aliphatic, or cycloaliphatic diisocyanates and capped with hydroxy acrylates.

For instance, a polyester of hexanedioic acid, diethylene glycol, terminated with isophorone diisocyanate, capped with 2-hydroxyethyl acrylate (CAS 72121-94-9) and a hydroxy terminated polybutadiene terminated with isophorone diisocyanate, capped with 2-hydroxyethyl acrylate are appropriate examples.

In addition, difunctional urethane acrylate oligomers, such as a polyester of hexanedioic acid and diethylene glycol, terminated with isophorone diisocyanate, capped with 2-hydroxyethyl acrylate (CAS 72121-94-9); a polypropylene glycol terminated with tolyene-2,6-diisocyanate, capped with 2-hydroxyethylacrylate (CAS 37302-70-8); a polyester of hexanedioic acid and diethylene glycol, terminated with 4,4′-methylenebis(cyclohexyl isocyanate), capped with 2-hydroxyethyl acrylate (CAS 69011-33-2); a polyester of hexanedioic acid, 1,2-ethanediol, and 1,2 propanediol, terminated with tolylene-2,4-diisocyanate, capped with 2-hydroxyethyl acrylate (CAS 69011-31-0); a polyester of hexanedioic acid, 1,2-ethanediol, and 1,2 propanediol, terminated with 4,4′-methylenebis(cyclohexyl isocyanate, capped with 2-hydroxyethyl acrylate (CAS 69011-32-1); and a polytetramethylene glycol ether terminated with 4,4′-methylenebis(cyclohexylisocyanate), capped with 2-hydroxyethyl acrylate.

Another example of a polyester urethane (meth)acrylate is one with a polyurethane backbone, at least a portion of which includes a urethane linkage formed from isophorane diisocyanate. For instance, such a (meth)acrylate-functionalized urethane is made from a polyester of hexanedioic acid, diethylene glycol, terminated with isophorone diisocyanate, capped with 2-hydroxyethyl acrylate.

Alkyl (meth)acrylates useful in formulating the (meth)acrylate-functionalized urethanes include isobornyl(meth)acrylate, isodecyl(meth)acrylate, lauryl(meth)acrylate, cyclic trimethylolpropane formal acrylate, octyldecyl acrylate, tetrahydrofurfuryl(meth)acrylate, tridecyl(meth)acrylate, and hydroxy alkyl(meth)acrylates, among others.

Hydroxy alkyl(meth)acrylates include 2-hydroxyethyl(meth)acrylate, phenoxyethyl(meth)acrylate, N-vinyl caprolactam, N,N-dimethyl acrylamide, 2(2-ethoxyethoxy) ethyl acrylate, caprolactone acrylate, polypropylene glycol monomethacrylate, 1,3-butylene glycol dimethacrylate, 1,4-butanediol dimethacrylate, 1,6 hexanediol di(meth)acrylate, tricyclodecane dimethanol di(meth)acrylate, tripropylene glycol diacrylate, ethoxylated trimethylolpropane triacrylate, trimethylolpropane triacrylate, tris(2-hydroxy ethyl) isocyanurate triacrylate, and combinations thereof.

Instead of hydroxy ethyl(meth)acrylate, 1,4-butanediol dimethacrylate, 1,6 hexanediol di(meth)acrylate, tricyclodecane dimethanol di(meth)acrylate, tripropylene glycol diacrylate, ethoxylated trimethylolpropane triacrylate, trimethylolpropane triacrylate, and tris(2-hydroxy ethyl) isocyanurate triacrylate may be used as well.

Another example of a suitable polyester urethane (meth)acrylate is made from a saturated polyester diol (such as DESMOPHEN S-1011-35, available commercially from Covestro LLC, Pittsburgh, PA), dicyclohexylmethane-4,4′-diisocyanate, and 2-hydroxyethyl acrylate, the reaction product of which may then be diluted with isobornyl acrylate for ease of handling.

Still another example of a useful polyester urethane (meth)acrylate is made from a hydroxy functionalized, polyester (available commercially as KURARAY Polyol P-2010) and TDI, together with hydroxypropyl (meth)acrylate and isobornyl (meth)acrylate; and one made from polyTHF (with a Mw of 2,000) and TDI, together with HBPA, hydroxypropyl (meth)acrylate, hydroxyethyl (meth)acrylate and isobornyl (meth)acrylate.

Another example of a useful polyester urethane (meth)acrylate is a block resin noted as cyclohexanol, 4,4-(1-methylethylidene)bis-, polymer with 1,3-disocyanatomethylbenzene and tetrahydrofuran, propylene glycol monomer (CAS No. 2243075-64-9), made in sequential steps from the reaction of the propylene glycol monomer and dicarboxylic acids to form polyester diols, followed by reaction with toluene diisocyanate and finally capping with hydroxy propyl(meth)acrylate.

Hydrophobic (meth)acrylate-functionalized urethanes may be selected from aliphatic urethane (meth)acrylates, aromatic urethane (meth)acrylates and mixtures thereof, such as polybutadiene based urethane (meth)acrylates, polyisobutylene based urethane (meth)acrylates, polyisoprene based urethane (meth)acrylate, polybutyl rubber based urethane (meth)acrylates and the mixtures thereof. Suitable commercially available hydrophobic urethane (meth)acrylates include UT-4462 and UV36301B90 available from Nippon Gohsei; CN 9014 available from Sartomer; and SUO-H8628 available from SHIIN-A T&C.

Other suitable polyester urethane (meth)acrylates include those disclosed in U.S. Pat. Nos. 4,018,851, 4,295,909 and 4,309,526 to Baccei, and U.S. Pat. Nos. Re 33,211, 4,751,273, 4,775,732, 5,019,636 and 5,139,872 to Lapin et al.

Thus, polyester urethane (meth)acrylates may be chosen from a variety of materials, some of which are commercially available from Dymax Corporation, Torrington, CT and are recited below in the tables together with certain published features:

Polyester Urethane Acrylates

| | | Elongation at |
|---|---|---|
| Name | Functionality | Break, % |
| BR-744BT | 2 | 407 |
| BR-744SD | 2 | 321 |
| BR-7432GB | 2 | 350 |
| BR-7432G130 | 2 | 180 |

Polyester Urethane Methacrylates

| | | Elongation at |
|---|---|---|
| Name | Functionality | Break, % |
| BR-742M | 2 | 60 |
| BR-742MS | 2 | 60 |
| BR-741 | 2 | 10 |

Other polyester urethane acrylates and methacrylates available commercially from Dymax include BR-742S, BR-741, BR-441BI20, BR-744BT, BR-771F, BR-371S, BR-374, BR-3042, BR-571, and BR-930D.

The polyester urethane (meth)acrylate should have a molecular weight in the range of about 2000 to about 5000 Mn, such as about 3500 Mn.

The polyester urethane (meth)acrylate should be used in an amount within the range of from about 10 percent by weight to about 60 percent by weight, for example from about 15 percent by weight to about 50 percent by weight by weight, based on the total weight of the Part B composition.

In addition to the free radical curable component, Part B also includes a transition metal compound. A non-exhaustive list of representative examples of the transition metal compounds are copper, vanadium, cobalt and iron compounds. For instance, as regards copper compounds, copper compounds where copper enjoys a 1+ or 2+ valence state are desirable. A non-exhaustive list of examples of such copper (I) and (II) compounds include copper (II) 3,5-diisopropylsalicylate hydrate, copper bis(2,2,6,6-tetramethyl-3,5-heptanedionate), copper (II) hydroxide phosphate, copper (II) chloride, Cu(I) bromide, Cu(II) bromide, copper (II) acetate monohydrate, tetrakis(acetonitrile)copper (I) hexafluorophosphate, copper (II) formate hydrate, tetrakisacetonitrile copper (I) triflate, copper(II)tetrafluoroborate, copper (II) perchlorate, tetrakis(acetonitrile)copper (I) tetrafluoroborate, copper (II) hydroxide, copper (II) hexafluoroacetylacetonate hydrate and copper (II) carbonate. These copper (I) and (II) compounds should be used in an amount such that when dissolved or suspended in a carrier vehicle, such as a (meth)acrylate, a concentration of about 100 ppm to about 10,000 ppm, such as about 500 ppm to about 5000 ppm, for instance about 1,000 ppm is present in the solution or suspension.

As regards vanadium compounds, vanadium compounds where vanadium enjoys a 2+ and 3+ valence state are desirable. Examples of such vanadium (III) compounds include vanadyl naphthanate and vanadyl acetylacetonate. These vanadium (III) compounds should be used in an amount of 50 ppm to about 5,000 ppm, such as about 500 ppm to about 2,500 ppm, for instance about 1,000 ppm.

As regards cobalt compounds, cobalt compounds where cobalt enjoys a 2+ valence state are desirable. Examples of such cobalt (II) compounds include cobalt naphthenate, cobalt tetrafluoroborate and cobalt acetylacetonate. These cobalt (II) compounds should be used in an amount of about 100 ppm to about 1000 ppm.

As regards iron compounds, iron compounds where iron enjoys a 3+ valence state are desirable. Examples of such iron (III) compounds include iron acetate, iron acetylacetonate, iron tetrafluoroborate, iron perchlorate, and iron chloride. These iron compounds should be used in an amount of about 100 ppm to about 1000 ppm.

In addition, the Part B composition should include at least one of an aliphatic urethane diacrylate, an anhydride and maleimide-, itaconimide- or nadimide-containing compounds and combinations thereof.

The aliphatic urethane diacrylate may be chosen from a host of materials, many of which are commercially available. For instance, with reference to the table below, PHOTOMER 6210, 6230 and 6892, which are each available commercially from IGM Resins Inc.; and CN1963, CN2207, CN2920, CN9009, CN9167US, CN9290US, and CN9026 that each are available from Sartomer division of Arkema Inc., Exton, PA.

| | | Elongation at |
|---|---|---|
| Oligomer | Functionality | Break, % |
| PHOTOMER 6210 | 2 | 40 |
| PHOTOMER 6230 | 2 | 70 |
| PHOTOMER 6892 | 3 | 47 |
| CN1967 | 2 | 27 |
| CN2207 | 2 | 4 |
| CN2920 | 2 | 7 |
| CN9009 | 2 | 140 |
| CN9167US | 2 | 3 |
| CN9290US | 2 | 125 |
| CN9026 | 6 | 4 |

Of particular interest, are those available commercially from IGM Resins. For instance, PHOTOMER 6210 is described by the manufacturer as a proprietary, non-yellowing aliphatic urethane diacrylate developed for radiation curable systems. This premium oligomer with very low viscosity provides excellent light stability, chemical resistance, abrasion resistance and flexibility. The low viscosity of this urethane acrylate allows formulators wide formulating latitude, permits high oligomer content or lower formulation viscosities. Also this oligomer exhibits low odor, good cure speed and excellent adhesion to various plastic and metal substrates. This oligomer also has relatively lower Mn (about 1400), which increases the crosslink density, which will help with the higher temperature resistance.

The aliphatic urethane diacrylate should have a molecular weight of about 900 to about 1900 Mn, such as about 1400 Mn.

The aliphatic urethane diacrylate, when present, should be used in an amount within the range of about 10 percent by weight to about 60 percent by weight, such as from about 15 percent by weight to about 40 percent by weight, for example from about 26 percent by weight to about 38 percent by weight by weight, based on the total weight of the Part B composition.

Desirably, the polyester urethane (meth)acrylate and the aliphatic urethane diacrylate, when present, should be present in about a 2:1 to about 1:1 by weight ratio.

The anhydride may be chosen from a variety of materials, desirably materials having two or more anhydride functional groups. One such anhydride is available commercially from Cray Valley under the tradename RICOBOND 1739, which is described by the manufacturer as maleinized polybutadiene.

The anhydride, when present, should be used in an amount within the range of about 0.5% to about 12, such as about 2 to about 10, desirably about 4 to about 8 percent by weight, based on the total weight of the Part B composition.

The anhydride should have a molecular weight in the range of about 200 to about 10,000 Mn, such as about 5400 Mn. Other examples of anhydrides include styrene-maleic anhydride copolymer, polyethylene-alt-maleic anhydride, acrylate-maleic anhydride terpolymer available commercially from Distrupol, UK, ethylene-acrylic ester-maleic anhydride terpolymer known by the trade name LOTADER 4720 and available commercially from Arkema, polyisoprene-graft-maleic anhydride, ethylene-acrylic ester-maleic anhydride terpolymer, copolymers of itaconic anhydride and acrylates such as MMA, itaconic anhydride-styrene copolymers. Other commercially available aromatic dianhydrides and polyanhydrides can also be used.

The maleimide-, nadimide-, and itaconimide-containing compounds include those compounds having the following structures I, II and III, respectively

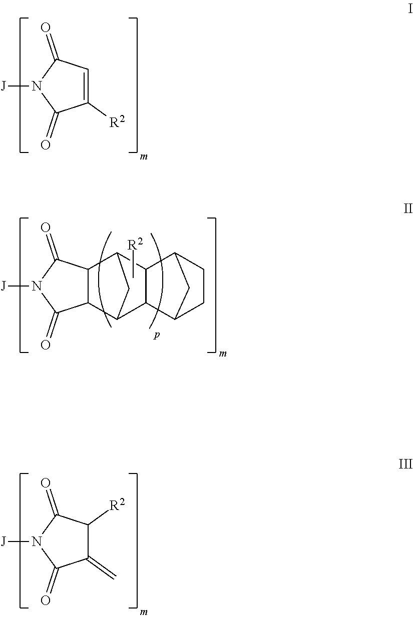

where:
m=1-15,
p=0-15,
   each R² is independently selected from hydrogen or lower alkyl, and
   J is a monovalent or a polyvalent moiety comprising organic or organosiloxane radicals, and combinations of two or more thereof.

More specific representations of the maleimides, nadimides, and itaconimides include those corresponding to structures I, II, or III, respectively, where m=1-6, p 32 0, R² is independently selected from hydrogen or lower alkyl, and J is a monovalent or polyvalent radical selected from hydrocarbyl, substituted hydrocarbyl, heteroatom-containing hydrocarbyl, substituted heteroatom-containing hydrocarbyl, hydrocarbylene, substituted hydrocarbylene, heteroatom-containing hydrocarbylene, substituted heteroatom-containing hydrocarbylene, polysiloxane, polysiloxane-polyurethane block copolymer, and combinations of two or more thereof, optionally containing one or more linkers selected from a covalent bond, —O—, —S—, —NR—, —O—C(O)—, —O—C(O)—O—, —O—C(O)—NR—, —NR—C(O)—, —NR—C(O)—O—, —NR—C(O)—NR—, —S—C(O)—, —S—C (O)—O—, —S—C(O)—NR—, —S(O)—, —S(O)₂—, —O—S(O)₂—, —O—S(O)₂—O—, —O—S(O)₂—NR—, —O—S(O)₂—NR—, —O—S(O)—O—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR —C(S)—O—, —O—NR—C(S)—NR—, —NR—O—C(S)—, —NR—O—C(S)—O—, —NR—O—C(S) —NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—-, —S—S(O)₂—NR—, —NR—O—S(O)₂—O—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)₂—NR—, —O—NR—S(O)₂—O—, —O—NR—S(O)₂—NR—, —O—NR—S(O)₂—, —O—P(P)R₂—, —S—P(O) R₂—, —NR—P(O)R₂—, where each R is independently hydrogen, alkyl or substituted alkyl, and combinations of any two or more thereof.

When one or more of the above described monovalent or polyvalent groups contain one or more of the above described linkers to form the “J” appendage of a maleimide, nadimide or itaconimide group, as readily recognized by those of skill in the art, a wide variety of linkers can be produced, such as, for example, oxyalkyl, thioalkyl, aminoalkyl, carboxylalkyl, oxyalkenyl, thioalkenyl, aminoalkenyl, carboxyalkynyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkynylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl, oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenyle aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, aminoalkynylarylene, carboxyalkenylarylene, oxyarylalkynylene, thioarylalkynylene, aminoarylalkynylene, carboxy arylalkynylene, oxyalkynylarylene, thioalkynylarylene, aminoalkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, carboxyheteroatom-containing di- or polyvalent cyclic moiety, disulfide, sulfonamide, and the like. ne, aminocycloalkenylene, carboxycycloalkenylene, oxyarylene, thioarylene, aminoarylene, carboxyarylene, oxyalkylarylene, thioalkylarylene,

In another embodiment, maleimides, nadimides, and itaconimides contemplated for use in the practice of the present invention have the structures I, II, and III, where m=1-6, p=0-6, and J is selected from saturated straight chain alkyl or branched chain alkyl, optionally containing optionally substituted aryl moieties as substituents on the alkyl chain or as part of the backbone of the alkyl chain, and where the alkyl chains have up to about 20 carbon atoms;

a siloxane having the structure: —(C(R³)₂)_{d}—[Si(R⁴)₂—O]_{f}—Si(R⁴)₂—(C(R³)₂)ₑ—, —(C(R³)₂)_{d}—C(R³)—(C(O)O—(C(R³)₂)_{d}—[Si(R⁴)₂—O—]_{f}—Si)R⁴)₂—C(R³)₂)ₑ—O(O)C—(C(R³)₂)e—, or —(C(R³)₂)_{d}—C(R³)—O(O)C—(C(R³)₂)_{d}—[Si(R⁴)₂—O]_{f}—Si(R⁴)₂)—(C(R³)₂)ₑ——C(O)—(C(R³)₂)ₑ—, where:

each R³ is independently hydrogen, alkyl or substituted alkyl, alkyl,

each R⁴ is independently hydrogen, lower alkyl or aryl,

d=1-10,

e=1-10, and

f=1-50;

a polyalkylene oxide having the structure:

[(CR₂)ᵣ—O—]_{f}—(CR₂)ₛ—

where:

each R is independently hydrogen, alkyl or substituted alkkyl,

r=1-10,

s=1-10, and

f is as defined above;

aromatic groups having the structure:

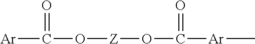

where:
each Ar is a monosubstituted, disubstituted or trisubstituted aromatic or heteroaromatic ring having in the range of 3 up to 10 carbon atoms, and
Z is:

saturated straight chain alkylene or branched chain alkylene, optionally containing saturated cyclic moieties as substituents on the alkylene chain or as part of the backbone of the alkylene chain, or

polyalkylene oxides having the structure:

[(CR₂)ᵣ—O—]_{q}—(CR₂)ₐ—

where:

each R is independently hydrogen, alkyl or substituted alkyl, r and s are each defined as above, and

q falls in the range of 1 up to 50;

di- or tri-substituted aromatic moieties having the structure:

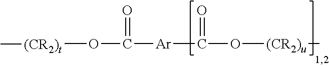

where:
each R is independently hydrogen, alkyl or substituted alkyl,
t falls in the range of 2 up to 10,
u falls in the range of 2 up to 10, and
Ar is as defined above;

aromatic groups having the structure:

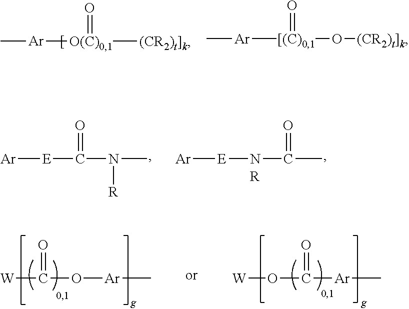

where:
each R is independently hydrogen, alkyl or substituted alkyl,
t=2-10,
k=1, 2 or 3,
g=1 up to about 50,
each Ar is as defined above,
E is —O— or —NR⁵—, where R⁵ is hydrogen or lower alkyl; and
W is straight or branched chain alkyl, alkylene, oxyalkylene, alkenyl, alkenylene, oxyalkenylene, ester, or polyester, a siloxane having the structure —(C(R³)₂)_{d}—[Si(R⁴)₂—O]_{f}—Si(R⁴)₂—(C(R³)₂)ₑ—, —(C(R³)₂)_{d}—C(R³)—C(O)O—(C(R³)₂)_{d}—[Si(R⁴)₂—O]_{f}—Si(R⁴)₂—(C(R³)₂)ₑ—O(O)C—C(R³)₂)ₑ—, or —(C(R³)₂)_{d}—C(R³)—O(O)C—(C(R³)₂(_{d}—[Si(R⁴)₂—O]_{f}—Si(R⁴)₂—(C(R³)₂)₂)ₑ—C(O)O—(C(R³)₂)ₑ13, where:

each R³ is independently hydrogen, alkyl or substituted alkyl, where:

each R ⁴ is independently hydrogen, lower alkyl or aryl,

d=1-10,

e=1-10, and

f=1-50;

a polyalkylene oxide having the structure:

—[(CR₂)ᵣ—O—]_{f}—(CR₂)ₛ—

where:
each R is independently hydrogen, alkyl or substituted alkyl,
r=1-10,
s=1-10, and
f is as defined above;
optionally containing substituents selected from hydroxy, alkoxy, carboxy, nitrile, cycloalkyl or cycloalkenyl;
a urethane group having the structure:

R⁷—U—C(O)—NR⁶—R⁸—NR⁶—C(O)—(O—C—O—NR⁶—R⁸—NR⁶—C(O))ᵥU—R⁸—

where:
each R⁶ is independently hydrogen or lower alkyl,
each R⁷ is independently an alkyl, aryl, or arylalkyl group having 1 to 18 carbon atoms,
each R⁸ is an alkyl or alkyloxy chain having up to about 100 atoms in the chain, optionally substituted with Ar,
U is —O—, —S—, —N(R)—, or —P(L)_{1,2}—,
   where R as defined above, and where each L is independently ═O, ═S, —OR or —R; and
v=0-50;
   polycyclic alkenyl; or mixtures of any two or more thereof.

In a more specific recitation of such maleimide-, nadimide-, and itaconimide-containing compounds of structures I, II and III, respectively, each R is independently hydrogen or lower alkyl (such as C₁₋₄), —J— comprises a branched chain alkyl, alkylene, alkylene oxide, alkylene carboxyl or alkylene amido species having sufficient length and branching to render the maleimide, nadimide and/or itaconimide compound a liquid, and m is 1, 2 or 3.

Particularly desirable maleimide-containing compounds include those have two maleimide groups with an aromatic group therebetween, such as a phenyl, biphenyl, bisphenyl or napthyl linkage.

The maleimide-, nadimide-, and itaconimide-containing compound, when present, should be used in an amount within the range of about 2 to about 15, such as about 5 to about 10, desirably about 6 to about 8 percent by weight, based on the total weight of the Part B composition.

As discussed above, additives may be included in either or both of the Part A or the Part B compositions to influence a variety of performance properties.

Fillers contemplated for use include, for example, aluminum nitride, boron nitride, silicon carbide, diamond, graphite, beryllium oxide, magnesia, silicas, such as fumed silica or fused silica, alumina, perfluorinated hydrocarbon polymers (i.e., TEFLON), thermoplastic polymers, thermoplastic elastomers, mica, glass powder and the like. Preferably, the particle size of these fillers will be about 20 microns or less.

As regards silicas, the silica may have a mean particle diameter on the nanoparticle size; that is, having a mean particle diameter on the order of 10 -9 meters. The silica nanoparticles can be pre-dispersed in epoxy resins and may be selected from those available under the tradename NANOCRYL, from Nanoresins, Germany. NANOCRYL is a tradename for a product family of silica nanoparticle reinforced (meth)acrylates. The silica phase consists of surface-modified, synthetic SiO2 nanospheres with less than 50 nm diameter and an extremely narrow particle size distribution. The SiO₂ nanospheres are agglomerate-free dispersions in the (meth)acrylate matrix resulting in a low viscosity for resins containing up to 50 percent by weight silica.

The silica component should be present in an amount in the range of about 1 to about 60 percent by weight, such as about 3 to about 30 percent by weight, desirably about 5 to about 20 percent by weight, based on the total weight of the composition.

Tougheners contemplated for use particularly in the Part A composition include elastomeric polymers selected from elastomeric copolymers of a lower alkene monomer and (i) acrylic acid esters, (ii) methacrylic acid esters or (iii) vinyl acetate, such as acrylic rubbers; polyester urethanes; ethylene-vinyl acetates; fluorinated rubbers; isoprene-acrylonitrile polymers; chlorosulfinated polyethylenes; and homopolymers of polyvinyl acetate were found to be particularly useful. [See U.S. Pat. No. 4,440,910 (O'Connor), the disclosures of each of which are hereby expressly incorporated herein by reference.] The elastomeric polymers are described in the '910 patent as either homopolymers of alkyl esters of acrylic acid; copolymers of another polymerizable monomer, such as lower alkenes, with an alkyl or alkoxy ester of acrylic acid; and copolymers of alkyl or alkoxy esters of acrylic acid. Other unsaturated monomers which may be copolymerized with the alkyl and alkoxy esters of acrylic include dienes, reactive halogen-containing unsaturated compounds and other acrylic monomers such as acrylamides.

For instance, one group of such elastomeric polymers are copolymers of methyl acrylate and ethylene, manufactured by DuPont, under the name of VAMAC, such as VAMAC N123 and VAMAC B-124. VAMAC N123 and VAMAC B-124 are reported by DuPont to be a master batch of ethylene/acrylic elastomer. The DuPont material VAMAC G is a similar copolymer but contains no fillers to provide color or stabilizers. VAMAC VCS rubber appears to be the base rubber, from which the remaining members of the VAMAC product line are compounded. VAMAC VCS (also known as VAMAC MR) is a reaction product of the combination of ethylene, methyl acrylate and monomers having carboxylic acid cure sites, which once formed is then substantially free of processing aids (such as the release agents octadecyl amine, complex organic phosphate esters and/or stearic acid), and anti-oxidants (such as substituted diphenyl amine).

DuPont provides to the market under the trade designation VAMAC VMX 1012 and VCD 6200, rubbers which are made from ethylene and methyl acrylate. It is believed that the VAMAC VMX 1012 rubber possesses little to no carboxylic acid in the polymer backbone. Like the VAMAC VCS rubber, the VAMAC VMX 1012 and VCD 6200 rubbers are substantially free of processing aids such as the release agents octadecyl amine, complex organic phosphate esters and/or stearic acid, and anti-oxidants, such as substituted diphenyl amine, noted above. All of these VAMAC elastomeric polymers are useful herein.

In addition, vinylidene chloride-acrylonitrile copolymers [see U.S. Pat. No. 4,102,945 (Gleave)] and vinyl chloride/vinyl acetate copolymers [see U.S. Pat. 4,444,933 (Columbus)] may be included in the Part A composition. Of course, the disclosures of each these U.S. patents are hereby incorporated herein by reference in their entirety.

Copolymers of polyethylene and polyvinyl acetate, available commercially under the trade name LEVAMELT by LANXESS Limited, are useful.

A range of LEVAMELT-branded copolymers are available and includes for example, LEVAMELT 400, LEVAMELT 600 and LEVAMELT 900. The LEVAMELT products differ in the amount of vinyl acetate present. For example, LEVAMELT 400 comprises an ethylene-vinyl acetate copolymer comprising 40 percent by weight vinyl acetate. The LEVAMELT products are supplied in granular form. The granules are almost colourless and dusted with silica and talc. LEVAMELT consists of methylene units forming a saturated main chain with pendant acetate groups. The presence of a fully saturated main chain is an indication that LEVAMELT-branded copolymers are particularly stable; they do not contain any reactive double bonds which make conventional rubbers prone to aging reactions, ozone and UV light. The saturated backbone is reported to make the polymer robust.

Interestingly, depending on the ratio of polyethylene/polyvinylacetate, the solubilities of these LEVAMELT elastomers change in different monomers and also the ability to toughen changes as a result of the solubility.

The LEVAMELT elastomers are available in pellet form and are easier to formulate than other known elastomeric toughening agents.

LEVAPREN-branded copolymers, also from Lanxess, may also be used.

VINNOL surface coating resins available commercially from Wacker Chemie AG, Munich, Germany represent a broad range of vinyl chloride-derived copolymers and terpolymers that are promoted for use in different industrial applications. The main constituents of these polymers are different compositions of vinyl chloride and vinyl acetate. The terpolymers of the VINNOL product line additionally contain carboxyl or hydroxyl groups. These vinyl chloride/vinyl acetate copolymers and terpolymers may also be used.

VINNOL surface coating resins with carboxyl groups are terpolymers of vinyl chloride, vinyl acetate and dicarboxylic acids, varying in terms of their molar composition and degree and process of polymerization. These terpolymers are reported to show excellent adhesion, particularly on metallic substrates.

VINNOL surface coating resins with hydroxyl groups are copolymers and terpolymers of vinyl chloride, hydroxyacrylate and dicarboxylate, varying in terms of their composition and degree of polymerization.

VINNOL surface coating resins without functional groups are copolymers of vinyl chloride and vinyl acetate of variable molar composition and degree of polymerization.

Rubber particles, especially rubber particles that have relatively small average particle size (e.g., less than about 500 nm or less than about 200 nm), may also be included, particularly in the Part B composition. The rubber particles may or may not have a shell common to known core-shell structures.

In the case of rubber particles having a core-shell structure, such particles generally have a core comprised of a polymeric material having elastomeric or rubbery properties (i.e., a glass transition temperature less than about 0° C., e.g., less than about −30° C.) surrounded by a shell comprised of a non-elastomeric polymeric material (i.e., a thermoplastic or thermoset/crosslinked polymer having a glass transition temperature greater than ambient temperatures, e.g., greater than about 50° C.). For example, the core may be comprised of a diene homopolymer or copolymer (for example, a homopolymer of butadiene or isoprene, a copolymer of butadiene or isoprene with one or more ethylenically unsaturated monomers such as vinyl aromatic monomers, (meth)acrylonitrile, (meth)acrylates, or the like) while the shell may be comprised of a polymer or copolymer of one or more monomers such as (meth)acrylates (e.g., methyl methacrylate), vinyl aromatic monomers (e.g., styrene), vinyl cyanides (e.g., acrylonitrile), unsaturated acids and anhydrides (e.g., acrylic acid), (meth)acrylamides, and the like having a suitably high glass transition temperature. Other rubbery polymers may also be suitably be used for the core, including polybutylacrylate or polysiloxane elastomer (e.g., polydimethylsiloxane, particularly crosslinked polydimethylsiloxane).

Typically, the core will comprise from about 50 to about 95 percent by weight of the rubber particles while the shell will comprise from about 5 to about 50 percent by weight of the rubber particles.

Preferably, the rubber particles are relatively small in size. For example, the average particle size may be from about 0.03 to about 2 microns or from about 0.05 to about 1 micron. The rubber particles may have an average diameter of less than about 500 nm, such as less than about 200 nm. For example, the core-shell rubber particles may have an average diameter within the range of from about 25 to about 200 nm.

When used, these core shell rubbers allow for toughening to occur in the composition and oftentimes in a predictable manner—in terms of temperature neutrality toward cure—because of the substantial uniform dispersion, which is ordinarily observed in the core shell rubbers as they are offered for sale commercially.

In the case of those rubber particles that do not have such a shell, the rubber particles may be based on the core of such structures.

Desirably, the rubber particles are relatively small in size. For example, the average particle size may be from about 0.03 to about 2 μ or from about 0.05 to about 1 μ. In certain embodiments of the invention, the rubber particles have an average diameter of less than about 500 nm. In other embodiments, the average particle size is less than about 200 nm. For example, the rubber particles may have an average diameter within the range of from about 25 to about 200 nm or from about 50 to about 150 nm.

The rubber particles may be used in a dry form or may be dispersed in a matrix, as noted above.

Typically, the composition may contain from about 5 to about 35 percent by weight rubber particles.

Combinations of different rubber particles may advantageously be used in the present invention. The rubber particles may differ, for example, in particle size, the glass transition temperatures of their respective materials, whether, to what extent and by what the materials are functionalized, and whether and how their surfaces are treated.

Rubber particles that are suitable for use in the present invention are available from commercial sources. For example, rubber particles supplied by Eliokem, Inc. may be used, such as NEP R0401 and NEP R401S (both based on acrylonitrile/butadiene copolymer); NEP R0501 (based on carboxylated acrylonitrile/butadiene copolymer; CAS No. 9010-81-5); NEP R0601A (based on hydroxy-terminated polydimethylsiloxane; CAS No. 70131-67-8); and NEP R0701 and NEP 0701S (based on butadiene/styrene/2-vinylpyridine copolymer; CAS No. 25053-48-9). Also those available under the PARALOID tradename, such as PARALOID 2314, PARALOID 2300, and PARALOID 2600, from Dow Chemical Co., Philadelphia, PA, and those available under the STAPHYLOID tradename, such as STAPHYLOID AC-3832, from Ganz Chemical Co., Ltd., Osaka, Japan.

Rubber particles that have been treated with a reactive gas or other reagent to modify the outer surfaces of the particles by, for instance, creating polar groups (e.g., hydroxyl groups, carboxylic acid groups) on the particle surface, are also suitable for use herein. Illustrative reactive gases include, for example, ozone, Cl₂, F₂, O₂, SO₃, and oxidative gases. Methods of surface modifying rubber particles using such reagents are known in the art and are described, for example, in U.S. Pat. Nos. 5,382,635; 5,506,283; 5,693,714; and 5,969,053, each of which being hereby expressly incorporated herein by reference in its entirety. Suitable surface modified rubber particles are also available from commercial sources, such as the rubbers sold under the tradename VISTAMER by Exousia Corporation.

Where the rubber particles are initially provided in dry form, it may be advantageous to ensure that such particles are well dispersed in the adhesive composition prior to curing the adhesive composition. That is, agglomerates of the rubber particles are preferably broken up so as to provide discrete individual rubber particles, which may be accomplished by intimate and thorough mixing of the dry rubber particles with other components of the adhesive composition.

Thickeners are also useful.

Stabilizers and inhibitors may also be employed to control and prevent premature peroxide decomposition and polymerization. The inhibitors may be selected from hydroquinones, benzoquinones, naphthoquinones, phenanthroquinones, anthraquinones, and substituted compounds thereof. Various phenols may also be used as inhibitors, such as 2,6-di-tertiary-butyl-4-methyl phenol. The inhibitors may be used in quantities of about 0.1 percent by weight to about 1.0 percent by weight by weight of the total composition without adverse effect on the curing rate of the polymerizable adhesive composition.

At least one of the first part or the second part may also include an organic acid having a pKₐ of about 12 or less, such as sulfimides, sulfonamides, citric acid, maleic acid, succinic acid, phthalic acid, di-carboxylic acid, maleic anhydride, maleic dianhydride, succinic anhydride, and phthalic anhydride,

In practice, each of the Part A and the Part B compositions are housed in separate containment vessels in a device prior to use, where in use the two parts are expressed from the vessels, mixed and applied onto a substrate surface. The vessels may be chambers of a dual chambered cartridge, where the separate parts are advanced through the chambers with plungers through an orifice (which may be a common one or adjacent ones) and then through a mixing dispense nozzle. Or the vessels may be coaxial or side-by-side pouches, which may be cut or torn and the contents thereof mixed and applied onto a substrate surface.

The invention will be more readily appreciated by a review of the examples, which follow.

### EXAMPLES

Reference to CA or cyanoacrylate in the Examples refers to ECA or ethyl-2-cyanoacrylate, respectively, unless otherwise noted.

An adhesive system was prepared where the Part A composition was based on ECA, mixed with t-BPB together with a boron trifluoride/methane sulfonic acid/sulfuric acid combination as an acidic component, and an ethylene/vinyl acetate copolymer. With reference to Table 1, the Part B compositions were prepared from the constituents listed in the specific amounts.

TABLE 1
Part B

| Constituents | | Sample Nos./Amt (wt%) | | | | | |
|---|---|---|---|---|---|---|---|
| Type | Identity | 1 | 2 | 3 | 5 | 6 | 7 |
| Free radical curable | Flex III! | 42.6 | 42.6 | | | | |
| component | CN2003 EU^{@} | 17.77 | 17.77 | 33.24 | 30 | 25 | 30.54 |
| | CN131B^{#} | | | | 7 | 13 | 12.7 |
| Polyester Urethane | BR-742S^{$} | 22.28 | 22.28 | 47.9 | 46.72 | 45.72 | 30 |
| Acrylate | | | | | | | |
| Aliphatic | PHOTOMER 6210^{%} | | | | | | 16 |
| Urethane | | | | | | | |
| Diacrylate | | | | | | | |
| Transition Metal | 20% Cu(ClO₄)₂•6H₂O | 2.5 | | 2.5 | 2.5 | 2.5 | 2.5 |
| | salt in ETMA | | | | | | |
| | 20% Cu(ClO₄)₂•6H₂O | | 2.5 | | | | |
| | salt in HPMA | | | | | | |
| Other | HOMBITAN LW\hat{ } | 0.75 | 0.75 | 0.75 | 0.75 | 0.75 | 0.75 |
| Additives | KAYAMER PM2^{&} | 0.03 | 0.03 | 0.03 | 0.03 | 0.03 | 0.03 |
| | ETMA | 6.55 | 6.55 | 8.08 | 5 | 5 | |
| Fumed Silica | Cab O Sil TS 720 | 7.5 | 7.5 | 7.5 | 8 | 8 | 7.5 |
| | Total | 100 | 100 | 100 | 100 | 100 | 100 |

!Made in sequential steps from the reaction of diols and dicarboxylic acids to form polyester diols, followed by reaction with toluene diisocyanate and finally capping with hydroxy propyl(meth)acrylate.
^{@}As described by Arkema, CN2003EU is a clear liquid modified epoxy acrylate for use in ultraviolet and electron beam curing compositions. Key properties include high flexibility, excellent adhesion on metal and plastics, and low shrinkage.
^{#}CN131B is a low viscosity aromatic monoacrylate oligomer that us used to produce fast curing, strong and flexible cured films. CN131B has lower residuals to assist compliance with FDA packaging requirements. Suggested applications include floor, glass, metal, and plastic coatings, electronics, photoresists, and inks.
^{$}According to Dymax, BR-742S is a difunctional polyester urethane acrylate.
^{%}According to IGM Resins, PHOTOMER 6210 is a proprietary, non-yellowing aliphatic urethane developed for radiation curable systems.
\hat{ }HOMBITAN LW by Venator Materials is a micronized white pigment based on an anatase titanium dioxide. Used in primers, mastic compounds, undercoats, fillers and extenders, mineral bound plasters, road-marking paints, lime paints and interior emulsion paints. HOMBITAN LW offers low abrasion. Provides high scattering power for extremely good dry and wet opacity.
^{&}BIS(2-METHACRYLOXYETHYL) PHOSPHATE

The two part adhesive systems, the Part B compositions of which are set forth in Table 1, were applied to a pair of substrates which were mated in an overlapped, off-set manner with the adhesive system disposed therebetween, and allowed to cure for 24 hours at room temperature. To form adhesives with a 1 mm thickness, 1 mm plastic shims were used to induce a 1 mm gap between the substrates to be bonded. The adhesive systems formed an adhesive bond between the substrates.

Table 2 captures the observations made on the two part adhesive systems (and the test methods followed to conduct the evaluation) in terms of drop impact strength, lap shear strength and hot strength, once the bonded assemblies were cured at a temperature of 40° C. for a period of time of about 24 hours. LOCTITE 4080, commercially available from Henkel Corporation, Rocky Hill, CT, is used as a control. LOCTITE 4080 shows in this order a drop impact of 12.45 at 0 mm gap, a drop impact of 1.65 at 1 mm gap, a lap shear strength on GBMS of 3446, a lap shear strength on G10 epoxy of 998, and a hot strength at 120° C. on GBMS of 220.

TABLE 2

| | Sample | Sample | Sample | Sample | Sample | Sample | Sample |
|---|---|---|---|---|---|---|---|
| Physical Property | No. 1 | No. 2 | No. 3 | No. 4 | No. 5 | No. 6 | No. 7 |
| Drop Impact, GBMS (0 mm, | 9.2 | 13.4 | 13 | 15.8 | 25.1 | 20.1 | 16.1 |
| ASTM 8903) | | | | | | | |
| Drop Impact, GBMS (1 mm, | 37.4 | 37.0 | 13.08 | 24.9 | 17.6 | 8.7 | 18.5 |
| ASTM 8903) | | | | | | | |
| Lap shear strength GBMS | 2893 | 3298 | 3710 | 3637 | 3920 | 3816 | 3317 |
| (ASTM 700) | | | | | | | |
| Lap shear strength, G10 Epoxy | 1157 | 1153 | 1401 | 828 | 1363 | | 1658 |
| (ASTM 700) | | | | | | | |
| Hot Strength @ 120° C., GBMS | 279 | 287 | 346 | 334 | 345 | 464 | 703 |
| (ASTM 700) | | | | | | | |

Many of the samples displayed in Tables 1 and 2 show both good impact performance at 1 mm gap and hot strength at a temperature of 120° C.

For instance, Sample Nos. 1-7 show impressive drop impact strength performance at 1 mm gap, when compared with the control. In addition, the lap shear strength of Sample Nos. 1-7 is at least comparable and oftentimes better than the control (except for Sample No. 4 and Sample Nos. 1-2 depending on the substrates used.

And one in particular sample, Sample No. 7, the hot strength is nearly 4 times as great as the control.

A higher percent by weight of the polyester urethane acrylate, BR-742S, in Sample Nos. 3, 4 and 5 appeared to improve the hot strengths further (Table 2 below). Even though BR-7425 has a relatively higher Tg, inclusion of the polyester urethane acrylate also improved toughness of the adhesive systems as evidenced by improved drop impact performance as compared to the control, LOCTITE 4080, especially at 1 mm gap (Sample Nos. 1-5,

Table 2). [Conventionally, one of ordinary skill in the art would expect that use of material generally with a higher Tg would negatively affect drop impact performance and toughness.]

Additional adhesive systems were prepared where the Part A composition was based as above on ECA, mixed with t-BPB together with a boron trifluoride/methane sulfonic acid/sulfuric acid combination as an acidic component, and an ethylene/vinyl acetate copolymer. With reference to Table 3, the Part B compositions used in the adhesive systems were prepared from the constituents listed in the specific amounts.

TABLE 3
Part B

| | |
|---|---|
| | Sample Nos./Amt |
| Constituents | (wt %) |

| Type | Identity | 8 | 9 |
|---|---|---|---|
| Free radical curable | Flex III^{!} | 42.6 | 42.6 |
| component | CN2003 EU^{@} | 17.77 | 17.77 |
| | HPMA | | 2 |
| | ETMA | 5.9 | |
| Polyester | BR-742S^{$} | 21.7 | 21.7 |
| Urethane | | | |
| Acrylate | | | |
| Anhydride | RICOBOND | 4.5 | |
| | 1739^{%} | | |
| Maleimide | BMI^{#} | | 6.4 |
| Transition Metal | Cu(ClO₄)₂•6H₂O | 0.5 | 0.5 |
| | salt | | |
| Other | HOMBITAN LW\hat{ } | 0.75 | 0.75 |
| Additives | KAYAMER PM2^{&} | 0.03 | 0.03 |
| Fumed Silica | Cab O Sil TS 720 | 7.5 | 7.5 |
| | Total | 100 | 100 |

^{!}Made in sequential steps from the reaction of diols and dicarboxylic acids to form polyester diols, followed by reaction with toluene diisocyanate and finally capping with hydroxy propyl(meth)acrylate
^{@}As described by Arkema, CN2003EU is a clear liquid modified epoxy acrylate for use in ultraviolet and electron beam curing compositions. Key properties include high flexibility, excellent adhesion on metal and plastics, and low shrinkage.
^{$}According to Dymax, BR-742S is a difunctional polyester urethane acrylate.
^{%}RICOBOND 1739 is a maleinized polybutadiene obtained from Cray Valley.
^{#}Made in accordance with U.S. Pat. No. 6,034,194 (Dershem).
\hat{ }HOMBITAN LW by Venator Materials is a micronized white pigment based on an anatase titanium dioxide. Used in primers, mastic compounds, undercoats, fillers and extenders, mineral bound plasters, road-marking paints, lime paints and interior emulsion paints. HOMBITAN LW offers low abrasion. Provides high scattering power for extremely good dry and wet opacity.
^{&}BIS(2-METHACRYLOXYETHYL) PHOSPHATE

The two part adhesive systems, the Part B compositions of which are set forth in Table 3, were applied to a pair of substrates which were mated in an overlapped, off-set manner with the adhesive system disposed therebetween, and allowed to cure for 24 hours at room temperature. The adhesive systems formed an adhesive bond between the substrates.

Table 4 captures the observations made on the adhesive systems (and the test methods followed) in terms of drop impact strength, lap shear strength and hot strength, once the bonded assemblies were cured at a temperature of 40° C. for a period of time of about 24 hours.

TABLE 4

| Physical Property | Sample No. 8 | Sample No. 9 |
|---|---|---|
| Drop Impact, GBMS | 6.1 | 14.0 |
| (0 mm, ASTM8903) | | |
| Drop Impact, GBMS | 4.6 | 25.8 |
| (1 mm, ASTM8903) | | |
| Lap shear strength | 2428 | 3120 |
| GBMS, ASTM700 | | |
| Lap shear strength, | 1426 | 1552 |
| G10 Epoxy, ASTM 700 | | |
| Hot Strength @ 120° C., | 641 | 293 |
| GBMS, ASTM700 | | |

As noted above and presented here again for convenience, LOCTITE 4080 shows in this order a drop impact of 12.45 at 0 mm gap, a drop impact of 1.65 at 1 mm gap, a lap shear strength on GBMS of 3446, a lap shear strength on G10 epoxy of 998, and a hot strength at 120° C. on GBMS of 220.

The samples displayed in Tables 3 and 4 show both good impact performance at 1 mm gap and hot strength at a temperature of 120° C.

For instance, Sample Nos. 8-9 (with an anhydride and a maleimide, respectively) show impressive drop impact strength performance at 1 mm gap, when compared with the control.

What is claimed is:

1. A two part curable composition comprising:
(a) a first part comprising a cyanoacrylate component and a peroxide component; and
(b) a second part comprising a free radical curable component and a transition metal, at least a portion of which comprises a polyester urethane (meth)acrylate having a Tg of greater than about 50° C., and
wherein the second part further comprises one or more of an aliphatic urethane diacrylate having a Tg of greater than about 30° C.; an anhydride; and at least one maleimide-, itaconimide- or nadimide-containing compound.

2. The composition of claim 1, wherein the polyester urethane (meth)acrylate and the aliphatic urethane diacrylate are present in about a 2:1 by weight ratio.

3. The composition of claim 1, wherein the polyester urethane (meth)acrylate has a molecular weight of about 2000 to about 5000 Mn.

4. The composition of claim 1, wherein the aliphatic urethane diacrylate has a molecular weight of about 900 to about 1900 Mn.

5. The composition of claim 1, wherein when the first part and the second part are mixed together the peroxide component initiates cure of the free radical curable component.

6. The composition of claim 1, wherein when the first part and the second part are mixed together and cured, a cured composition demonstrates at least one of lap shear strength on epoxy substrates of greater than 1000 psi and hot strength at a temperature of 120° C. on grit blasted mild steel substrates of greater than 300 psi.

7. The composition of claim 1, wherein the polyester urethane (meth)acrylate has a Tg of greater than about 60° C.

8. The composition of claim 1, wherein the polyester urethane (meth)acrylate has a Tg of greater than about 70° C.

9. The composition of claim 1, wherein the polyester urethane (meth)acrylate has a molecular weight of about 3500 Mn.

10. The composition of claim 1, wherein the aliphatic urethane diacrylate has a molecular weight of about 1400 Mn.

11. The composition of claim 1, wherein when the first part and the second part are mixed together and cured, a cured composition demonstrates at least one of lap shear strength on epoxy substrates of greater than 1500 psi and hot strength at a temperature of 120° C. on grit blasted mild steel substrates of greater than 500 psi.

12. The composition of claim 1, wherein the second part comprises a polyester urethane (meth)acrylate having a Tg of greater than about 50° C. and an aliphatic urethane diacrylate having a Tg of greater than about 30° C.

13. The composition of claim 1, wherein the anhydride has a molecular weight of about 5400 Mn.

14. The composition of claim 1, wherein the first part and the second part are present in a ratio of about 1:1 by volume.
